(19) United States
(12) Patent Application Publication
(10) Pub. No.: US 2024/0025393 A1
(43) Pub. Date: Jan. 25, 2024

(54) VEHICLE INTENTIONAL DRIFT DETECTION AND CONTROL

(71) Applicant: GM Global Technology Operations LLC, Detroit, MI (US)

(72) Inventors: Naser Mehrabi, Richmond Hill (CA); Nauman Sohani, Waterloo (CA); Mustafa Hakan Turhan, Kitchener (CA); Saurabh Kapoor, Markham (CA); Sresht Gurumoorthi Annadevara, Toronto (CA); SeyedAlireza Kasaiezadeh Mahabadi, Novi, MI (US); Hualin Tan, Novi, MI (US); James H. Holbrook, Fenton, MI (US)

(21) Appl. No.: 17/812,818

(22) Filed: Jul. 15, 2022

(51) Int. Cl. B60W 30/02; B60W 30/18

(52) U.S. Cl. CPC B60W 30/02; B60W 30/18172; B60W 2720/403; B60W 2720/20; B60W 2510/207; B60W 2540/10

(57) ABSTRACT

A system comprises a computer including a processor and a memory. The memory includes instructions such that the processor is programmed to: determine an occurrence of intentional drift event, and in response to determining the occurrence of the intentional drift event, determine a front torque target and a rear torque target.

### INTRODUCTION

The present disclosure relates to selecting a system that can determine whether a vehicle drift is an intentional drift event and determine torque distributions in response to the determination of the intentional drift event.

Vehicles typically include a torque generating system that generates drive torque. This drive torque is typically transferred to a driveline, i.e., axles, wheels, etc., of the vehicle via a transmission. During certain vehicle turn scenarios, oversteer or understeer occurs. For example, understeer is more prevalent in front-wheel drive powertrains whereas oversteer is more prevalent in rear-wheel drive powertrains.

Conventional electronic stability control (ESC) systems operate to correct vehicle oversteer/understeer. For example, vehicle yaw rate sensors can be monitored to detect vehicle oversteer/understeer and then adjusting the powertrain torque distribution in response to the detection.

### SUMMARY

A system comprises a computer including a processor and a memory. The memory includes instructions such that the processor is programmed to: determine an occurrence of intentional drift event, and, in response to determining the occurrence of the intentional drift event, determine a front torque target and a rear torque target.

In other features, the processor is further programmed to adjust a slip target in at least one rear wheel of a vehicle.

In other features, the vehicle comprises an All-Wheel Drive (AWD) vehicle.

In other features, the processor is further programmed to send a command to at least one vehicle actuator to adjust a torque distribution based on the front torque target and the rear torque target.

In other features, the processor is further programmed to determine whether an occurrence of a drift.

In other features, the processor is further programmed to determine that the occurrence of the drift is the intentional drift event based on an oversteer of a vehicle and no decrease in a throttle of the vehicle.

In other features, the processor is further programmed to send a command to at least one vehicle actuator to modify torque distribution between wheels according to a target side slip angle parameter.

A vehicle can include a computer. The computer includes a processor and a memory, and the memory includes instructions such that the processor is programmed to determine an occurrence of intentional drift event, and, in response to determining the occurrence of the intentional drift event, determine a front torque target and a rear torque target for the vehicle.

In other features, the processor is further programmed to adjust a slip target in at least one rear wheel of the vehicle.

In other features, the vehicle comprises an All-Wheel Drive (AWD) vehicle.

In other features, the processor is further programmed to send a command to at least one vehicle actuator to adjust a torque distribution based on the front torque target and the rear torque target.

In other features, the processor is further programmed to determine whether an occurrence of a drift.

In other features, the processor is further programmed to determine that the occurrence of the drift is the intentional drift event based on an oversteer of the vehicle and no decrease in a throttle of the vehicle.

In other features, the processor is further programmed to send a command to at least one vehicle actuator to modify torque distribution between wheels according to a target side slip angle parameter.

A method includes determining an occurrence of intentional drift event, and, in response to determining the occurrence of the intentional drift event, determining a front torque target and a rear torque target.

In other features, the method includes adjusting a slip target in at least one rear wheel of a vehicle.

In other features, the vehicle comprises an All-Wheel Drive (AWD) vehicle.

In other features, the method includes sending a command to at least one vehicle actuator to adjust a torque distribution based on the front torque target and the rear torque target.

In other features, the method includes determining an occurrence of a drift.

In other features, the method includes determining that the occurrence of the drift is the intentional drift event based on an oversteer of a vehicle and no decrease in a throttle of the vehicle

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a block diagram of an example system including a vehicle;

FIG. 2 is a block diagram of an example computing device;

FIG. 3 is a flow diagram illustrating an example process for determining whether a drift event is an intentional drift event; and

FIG. 4 is a flow diagram illustrating an example process for determining a control strategy for torque distribution based on the intentional drift event.

### DETAILED DESCRIPTION

The following description is merely exemplary in nature and is not intended to limit the present disclosure, application, or uses.

The present disclosure describes a system and a process that detects an oversteer event and determines whether the oversteer event is intentional. If the oversteer event is determined to be intentional, the system can redistribute a torque request to assist in maintaining stable drift. For example, during a determined intentional drift event, the system can determine one or more torque targets based on a driver torque request.

As used herein, understeer and oversteer can comprise instances of vehicle dynamics representing a vehicle sensitivity to steering. Oversteer can be defined as the vehicle turning by more than an amount commanded by an operator of the vehicle. Understeer can be defined as the vehicle turning by less than an amount commanded by the operator of the vehicle.

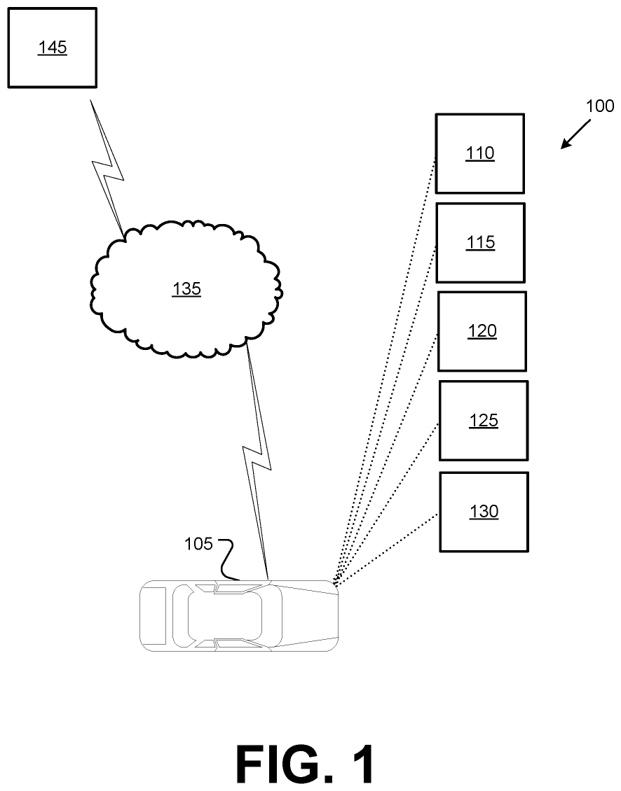

FIG. 1 is a block diagram of an example system 100. The system 100 includes a vehicle 105, which can comprise a land vehicle such as a car, truck, etc., an aerial vehicle, and/or an aquatic vehicle. The vehicle 105 includes a computer 110, vehicle sensors 115, actuators 120 to actuate various vehicle components 125, and a vehicle communications module 130. Via a network 135, the communications module 130 allows the computer 110 to communicate with a server 145.

Within the present context, the vehicle 105 comprises an All-Wheel Drive (AWD) vehicle. As such, the vehicle 105 includes one or more drive mechanisms that deliver torque from the engine to the wheels to cause rotation of the wheels. In an example implementation, the vehicle 105 further includes an electronic All-Wheel Drive (AWD) actuator that controls distribution of torque between a front axle of the vehicle 105 and a rear axle of the vehicle 105. The vehicle 105 can also include an electronic limited-slip differential actuator (eLSD) that controls a distribution of torque between a rear left wheel and a rear right wheel. During operation, a operator of the vehicle 105 can provide a torque request as input via an accelerator pedal.

The computer 110 may operate a vehicle 105 in an autonomous, a semi-autonomous mode, or a non-autonomous (manual) mode. For purposes of this disclosure, an autonomous mode is defined as one in which each of vehicle 105 propulsion, braking, and steering are controlled by the computer 110; in a semi-autonomous mode the computer 110 controls one or two of vehicles 105 propulsion, braking, and steering; in a non-autonomous mode a human operator controls each of vehicle 105 propulsion, braking, and steering.

The computer 110 may include programming to operate one or more of vehicle 105 brakes, propulsion (e.g., control of acceleration in the vehicle by controlling one or more of an internal combustion engine, electric motor, hybrid engine, etc.), steering, climate control, interior and/or exterior lights, etc., as well as to determine whether and when the computer 110, as opposed to a human operator, is to control such operations. Additionally, the computer 110 may be programmed to determine whether and when a human operator is to control such operations.

The computer 110 may include or be communicatively coupled to, e.g., via the vehicle 105 communications module 130 as described further below, more than one processor, e.g., included in electronic controller units (ECUs) or the like included in the vehicle 105 for monitoring and/or controlling various vehicle components 125, e.g., a powertrain controller, a brake controller, a steering controller, etc. Further, the computer 110 may communicate, via the vehicle 105 communications module 130, with a navigation system that uses the Global Position System (GPS). As an example, the computer 110 may request and receive location data of the vehicle 105. The location data may be in a known form, e.g., geo-coordinates (latitudinal and longitudinal coordinates).

The computer 110 is generally arranged for communications on the vehicle 105 communications module 130 and also with a vehicle 105 internal wired and/or wireless network, e.g., a bus or the like in the vehicle 105 such as a controller area network (CAN) or the like, and/or other wired and/or wireless mechanisms.

Via the vehicle 105 communications network, the computer 110 may transmit messages to various devices in the vehicle 105 and/or receive messages from the various devices, e.g., vehicle sensors 115, actuators 120, vehicle components 125, a human machine interface (HMI), etc. Alternatively or additionally, in cases where the computer 110 actually comprises a plurality of devices, the vehicle 105 communications network may be used for communications between devices represented as the computer 110 in this disclosure. Further, as mentioned below, various controllers and/or vehicle sensors 115 may provide data to the computer 110. The vehicle 105 communications network can include one or more gateway modules that provide interoperability between various networks and devices within the vehicle 105, such as protocol translators, impedance matchers, rate converters, and the like.

Vehicle sensors 115 may include a variety of devices such as are known to provide data to the computer 110. For example, the vehicle sensors 115 may include Light Detection and Ranging (lidar) sensor(s) 115, etc., disposed on a top of the vehicle 105, behind a vehicle 105 front windshield, around the vehicle 105, etc., that provide relative locations, sizes, and shapes of objects and/or conditions surrounding the vehicle 105. As another example, one or more radar sensors 115 fixed to vehicle 105 bumpers may provide data to provide and range velocity of objects (possibly including second vehicles 106), etc., relative to the location of the vehicle 105. The vehicle sensors 115 may further include camera sensor(s) 115, e.g., front view, side view, rear view, etc., providing images from a field of view inside and/or outside the vehicle 105.

The vehicle sensors 115 can also includes sensors that measure lateral velocity, longitudinal velocity, wheel/tire slippage, torque requests, and the like.

The vehicle 105 actuators 120 are implemented via circuits, chips, motors, or other electronic and or mechanical components that can actuate various vehicle subsystems in accordance with appropriate control signals as is known. The actuators 120 may be used to control components 125, including braking, acceleration, and steering of a vehicle 105.

In the context of the present disclosure, a vehicle component 125 is one or more hardware components adapted to perform a mechanical or electro-mechanical function or operation—such as moving the vehicle 105, slowing or stopping the vehicle 105, steering the vehicle 105, etc. Non-limiting examples of components 125 include a propulsion component (that includes, e.g., an internal combustion engine and/or an electric motor, etc.), a transmission component, a steering component (e.g., that may include one or more of a steering wheel, a steering rack, etc.), a brake component (as described below), a park assist component, an adaptive cruise control component, an adaptive steering component, a movable seat, etc.

In addition, the computer 110 may be configured for communicating via a vehicle-to-vehicle communication module or interface 130 with devices outside of the vehicle 105, e.g., through a vehicle to vehicle (V2V) or vehicle-to-infrastructure (V2I) wireless communications to another vehicle, to (typically via the network 135) a remote server 145, such as an edge server. The module 130 could include one or more mechanisms by which the computer 110 may communicate, including any desired combination of wireless (e.g., cellular, wireless, satellite, microwave and radio frequency) communication mechanisms and any desired network topology (or topologies when a plurality of communication mechanisms are utilized). Exemplary communications provided via the module 130 include cellular, Bluetooth®, IEEE 802.11, dedicated short-range communications (DSRC), and/or wide area networks (WAN), including the Internet, providing data communication services.

The network 135 can be one or more of various wired or wireless communication mechanisms, including any desired combination of wired (e.g., cable and fiber) and/or wireless (e.g., cellular, wireless, satellite, microwave, and radio frequency) communication mechanisms and any desired network topology (or topologies when multiple communication mechanisms are utilized). Exemplary communication networks include wireless communication networks (e.g., using Bluetooth, Bluetooth Low Energy (BLE), IEEE 802.11, vehicle-to-vehicle (V2V) such as Dedicated Short-Range Communications (DSRC), etc.), local area networks (LAN) and/or wide area networks (WAN), including the Internet, providing data communication services.

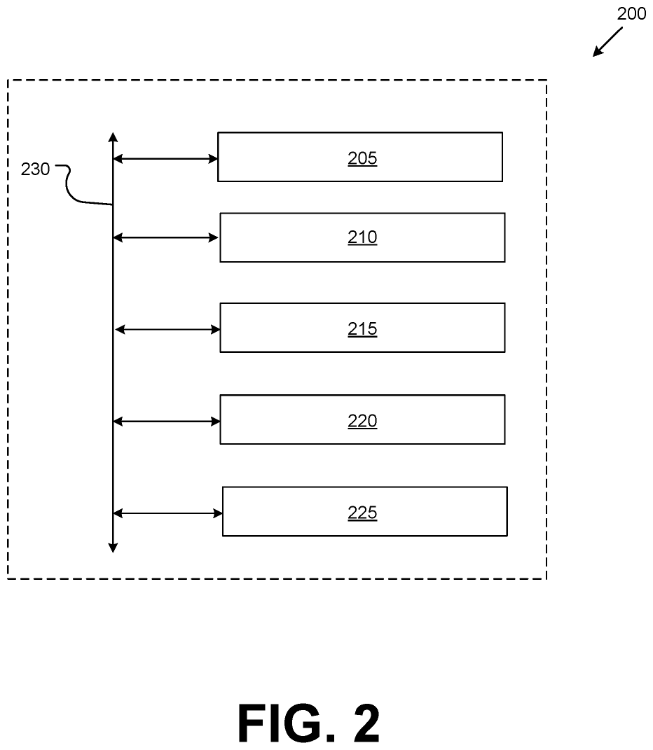

FIG. 2 illustrates an example computing device 200 i.e., computer 110, server(s) 145, that may be configured to perform one or more of the processes described herein. As shown, the computing device can comprise a processor 205, memory 210, a storage device 215, an I/O interface 220, and a communication interface 225. Furthermore, the computing device 200 can include an input device such as a touchscreen, mouse, keyboard, etc. In certain implementations, the computing device 200 can include fewer or more components than those shown in FIG. 2.

In particular implementations, processor(s) 205 includes hardware for executing instructions, such as those making up a computer program. As an example, and not by way of limitation, to execute instructions, processor(s) 205 may retrieve (or fetch) the instructions from an internal register, an internal cache, memory 210, or a storage device 215 and decode and execute them.

The computing device 200 includes memory 210, which is coupled to the processor(s) 205. The memory 210 may be used for storing data, metadata, and programs for execution by the processor(s). The memory 210 may include one or more of volatile and non-volatile memories, such as Random-Access Memory (“RAM”), Read Only Memory (“ROM”), a solid-state disk (“SSD”), Flash, Phase Change Memory (“PCM”), or other types of data storage. The memory 210 may be internal or distributed memory.

The computing device 200 includes a storage device 215 includes storage for storing data or instructions. As an example, and not by way of limitation, storage device 215 can comprise a non-transitory storage medium described above. The storage device 215 may include a hard disk drive (HDD), flash memory, a Universal Serial Bus (USB) drive or a combination of these or other storage devices.

The computing device 200 also includes one or more input or output (“I/O”) devices/interfaces 220, which are provided to allow a user to provide input to (such as user strokes), receive output from, and otherwise transfer data to and from the computing device 200. These I/O devices/interfaces 220 may include a mouse, keypad or a keyboard, a touch screen, camera, optical scanner, network interface, modem, other known I/O devices or a combination of such I/O devices/interfaces 220. The touch screen may be activated with a writing device or a finger.

The I/O devices/interfaces 220 may include one or more devices for presenting output to a user, including, but not limited to, a graphics engine, a display (e.g., a display screen), one or more output drivers (e.g., display drivers), one or more audio speakers, and one or more audio drivers. In certain implementations, devices/interfaces 220 is configured to provide graphical data to a display for presentation to a user. The graphical data may be representative of one or more graphical user interfaces and/or any other graphical content as may serve a particular implementation.

The computing device 200 can further include a communication interface 225. The communication interface 225 can include hardware, software, or both. The communication interface 225 can provide one or more interfaces for communication (such as, for example, packet-based communication) between the computing device and one or more other computing devices 200 or one or more networks. As an example, and not by way of limitation, communication interface 225 may include a network interface controller (NIC) or network adapter for communicating with an Ethernet or other wire-based network or a wireless NIC (WNIC) or wireless adapter for communicating with a wireless network, such as a WI-FI. The computing device 200 can further include a bus 230. The bus 230 can comprise hardware, software, or both that couples components of the computing device 200 to each other.

As discussed herein, the computer 110 receives sensor data from the sensors 115. The sensor data can comprise front axle torque T_{f}, rear axle torque Tᵣ, steering wheel angle δ_{f}, throttle input ρ, sideslip angle β, normal force at corner F_{z}, lateral force at corner F_{y}, longitudinal force at corner Fₓ, yaw rate r, and/or lateral acceleration a_{y}. The vehicle 105 can include one or more vehicle sensors 115 that measure the above-referenced vehicle states and provide sensor data representing the measured vehicle states to the computer 110.

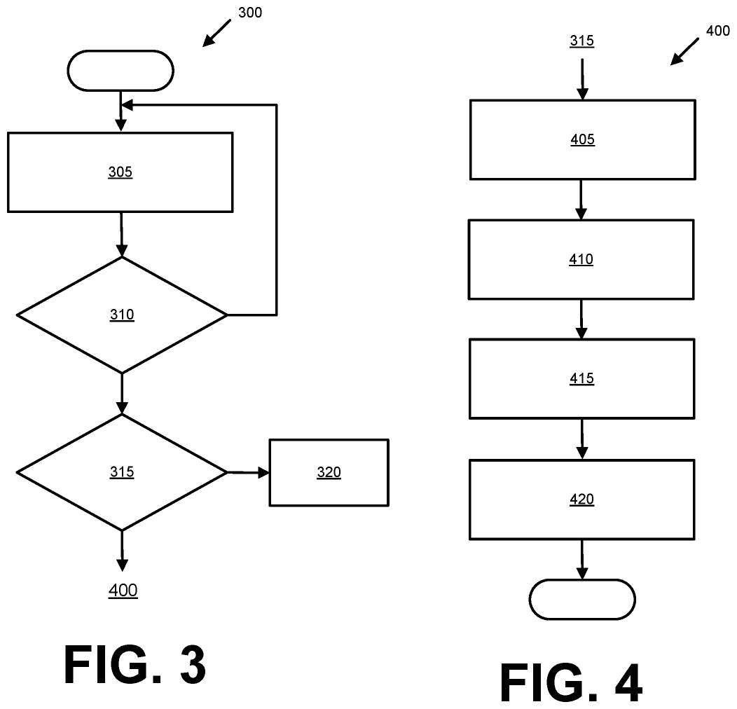

FIG. 3 illustrates an example process 300 for determining whether a drift event is an intentional drift event. Blocks of the process 300 can be executed by the computer 110. At block 305, sensor data from one or more vehicle sensors 115 is received. At block 310, a determination is made whether a drift has been detected, e.g., drift occurrence, drift event, etc. In an example implementation, the computer 110 determines that that a drift has occurred and/or may soon occur when an oversteer event occurs according to one or more conventional oversteering calculations.

If a drift has not been initiated, the process 300 returns to block 305. Otherwise, at block 315, the computer 110 determines whether the drift is an intentional drift event. The computer 110 can determine that the drift is an intentional drift event when there is no decrease in throttle of the vehicle 105 and the countersteer has been maintained.

If the initiated drift is not an intentional drift event, at block 320, the computer 110 implements conventional control logic for torque distribution. Otherwise, if the initiated drift is an intentional drift event, the process 300 transitions to process 400 described below to determine a vehicle 105 control strategy based on the intentional drift event.

FIG. 4 illustrates an example process 400 for determining a control strategy for torque distribution based on the intentional drift event. Blocks of the process 400 can be executed by the computer 110. At block 405, a slip target is adjusted. The computer 110 can adjust the slip target to allow additional slip in the rear wheels of the vehicle according to

Tₘᵢₙ^{Lim,whlslip}=K_{P}(Δλ−Λ*)+∫K_{I}(Δλ−Λ*)dt, Eq. 1,

where Δλ=λᵣₑₐᵣ−λ_{front}, Λ*:=Adjusted Target Ratio, Tₘᵢₙ^{Lim,whlslip} comprises the slip target, and K_{P} and K_{I} comprise understeering coefficients.

At block 410, the computer 110 computes an adjustment to a torque request minimum limit as defined in

Tₘᵢₙ^{Lim}=Tₘᵢₙ^{Lim,whlslip}+Adj, where Adj=K_{D}^{r}\dot{r}+K_{D}^{β}\dot{β}+K_{P}(β−β*), Eq. 2,

where β, \dot{β}, and β* comprise sideslip angle calculations.

At block 415, the computer 110 computes an adjustment to a torque request maximum limit as defined in

$${( \frac{{T}_{max}^{Lim}}{{R}_{eff} {μ}_{x} {F}_{Z}} )}^{2} + {( \frac{{F}_{y}^{desired}}{{μ}_{y} {F}_{Z}} )}^{2} = 1 , \qquad Eq . 3$$

$${F}_{yf}^{desired} = \frac{{ML}_{r} {rV}_{x}}{{L}_{f} + {L}_{r}} , \qquad Eq . 4$$

$$and$$

$${F}_{yr}^{desired} = \frac{{ML}_{f} {rV}_{χ}}{{L}_{f} + {L}_{r}} . \qquad Eq . 5$$

In an example implementation, the computer 110 adjusts the torque request minimum limit and the torque request maximum limit to support achieving a goal defined by

$$Goal : \{ \begin{matrix}\dot{r} = \dot{β} = 0 \\ β = {β}^{*}\end{matrix} , \qquad Eq . 6$$

where β* is defined as function of throttle and speed.

At block 420, the computer 110 computes front and rear desired torque targets based on a driver torque request. The computer 110 can compute the front torque target according to

T_{f}^{desired}=T_{req}−Tᵣ^{desired} Eq. 7,

and the rear torque target according to

Tᵣ^{desired}=max(T_{req}−Tₘᵢₙ^{Lim,F},Tₘᵢₙ^{Lim,R})−Tₘₐₓ^{Lim,R}. Eq. 8.

The process 400 then ends.

In addition to determining torque adjustments based on the intentional drift event, the computer 110 can also determine a target side-slip angle parameter. The target side slip angle parameter can be determined according to

β*=β̅+Δβ, Eq. 9,

where β̅=f(μ, δ, Vₓ, Fₓ) comprise drift equilibrium points Δβ is the corrective term as function of throttle input. \dot{β} is calculated by simultaneously solving conventional equations for a known surface (μ) and steering angle (δ). Within the present disclosure, the corrective term Δβ is calculated based on throttle position (ρ) compared to average throttle during drifting (ρ*).

Using the front and rear torque targets and the target side-slip angle parameter, the computer 110 can transmit one or more commands to the actuators 120 to alter a vehicle state accordingly. For example, the torque distributions can be determined according to the front and rear torque targets, and torque distribution between wheels can be modified according to the target side slip angle parameter.

In some example implementations, the server 145 can operate a performance simulation model of the vehicle 105. As such, the server 145 can perform one or more of the processes described above and generate dynamic parameters for the vehicle 105. In other words, the performance simulation model can receive inputs as discussed above and determine one or more outputs, e.g., front and rear torque targets, target side-slip angle, etc., based on the input.

The description of the present disclosure is merely exemplary in nature and variations that do not depart from the gist of the present disclosure are intended to be within the scope of the present disclosure. Such variations are not to be regarded as a departure from the spirit and scope of the present disclosure.

In general, the computing systems and/or devices described may employ any of a number of computer operating systems, including, but by no means limited to, versions and/or varieties of the Microsoft Automotive® operating system, the Microsoft Windows® operating system, the Unix operating system (e.g., the Solaris® operating system distributed by Oracle Corporation of Redwood Shores, California), the AIX UNIX operating system distributed by International Business Machines of Armonk, New York, the Linux operating system, the Mac OSX and iOS operating systems distributed by Apple Inc. of Cupertino, California, the BlackBerry OS distributed by Blackberry, Ltd. of Waterloo, Canada, and the Android operating system developed by Google, Inc. and the Open Handset Alliance, or the QNX® CAR Platform for Infotainment offered by QNX Software Systems. Examples of computing devices include, without limitation, an on-board vehicle computer, a computer workstation, a server, a desktop, notebook, laptop, or handheld computer, or some other computing system and/or device.

Computers and computing devices generally include computer executable instructions, where the instructions may be executable by one or more computing devices such as those listed above. Computer executable instructions may be compiled or interpreted from computer programs created using a variety of programming languages and/or technologies, including, without limitation, and either alone or in combination, Java™, C, C++, Matlab, Simulink, Stateflow, Visual Basic, Java Script, Perl, HTML, etc. Some of these applications may be compiled and executed on a virtual machine, such as the Java Virtual Machine, the Dalvik virtual machine, or the like. In general, a processor (e.g., a microprocessor) receives instructions, e.g., from a memory, a computer readable medium, etc., and executes these instructions, thereby performing one or more processes, including one or more of the processes described herein. Such instructions and other data may be stored and transmitted using a variety of computer readable media. A file in a computing device is generally a collection of data stored on a computer readable medium, such as a storage medium, a random-access memory, etc.

Memory may include a computer readable medium (also referred to as a processor readable medium) that includes any non-transitory (e.g., tangible) medium that participates in providing data (e.g., instructions) that may be read by a computer (e.g., by a processor of a computer). Such a medium may take many forms, including, but not limited to, non-volatile media and volatile media. Non-volatile media may include, for example, optical or magnetic disks and other persistent memory. Volatile media may include, for example, dynamic random-access memory (DRAM), which typically constitutes a main memory. Such instructions may be transmitted by one or more transmission media, including coaxial cables, copper wire and fiber optics, including the wires that comprise a system bus coupled to a processor of an ECU. Common forms of computer readable media include, for example, a floppy disk, a flexible disk, hard disk, magnetic tape, any other magnetic medium, a CD ROM, DVD, any other optical medium, punch cards, paper tape, any other physical medium with patterns of holes, a RAM, a PROM, an EPROM, a FLASH EEPROM, any other memory chip or cartridge, or any other medium from which a computer can read.

Databases, data repositories or other data stores described herein may include various kinds of mechanisms for storing, accessing, and retrieving various kinds of data, including a hierarchical database, a set of files in a file system, an application database in a proprietary format, a relational database management system (RDBMS), etc. Each such data store is generally included within a computing device employing a computer operating system such as one of those mentioned above, and are accessed via a network in any one or more of a variety of manners. A file system may be accessible from a computer operating system, and may include files stored in various formats. An RDBMS generally employs the Structured Query Language (SQL) in addition to a language for creating, storing, editing, and executing stored procedures, such as the PL/SQL language mentioned above.

In some examples, system elements may be implemented as computer readable instructions (e.g., software) on one or more computing devices (e.g., servers, personal computers, etc.), stored on computer readable media associated therewith (e.g., disks, memories, etc.). A computer program product may comprise such instructions stored on computer readable media for carrying out the functions described herein.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

With regard to the media, processes, systems, methods, heuristics, etc. described herein, it should be understood that, although the steps of such processes, etc. have been described as occurring according to a certain ordered sequence, such processes may be practiced with the described steps performed in an order other than the order described herein. It further should be understood that certain steps may be performed simultaneously, that other steps may be added, or that certain steps described herein may be omitted. In other words, the descriptions of processes herein are provided for the purpose of illustrating certain implementations, and should in no way be construed so as to limit the claims.

Accordingly, it is to be understood that the above description is intended to be illustrative and not restrictive. Many implementations and applications other than the examples provided would be apparent to those of skill in the art upon reading the above description. The scope of the invention should be determined, not with reference to the above description, but should instead be determined with reference to the appended claims, along with the full scope of equivalents to which such claims are entitled. It is anticipated and intended that future developments will occur in the arts discussed herein, and that the disclosed systems and methods will be incorporated into such future implementations. In sum, it should be understood that the invention is capable of modification and variation and is limited only by the following claims.

All terms used in the claims are intended to be given their plain and ordinary meanings as understood by those skilled in the art unless an explicit indication to the contrary in made herein. In particular, use of the singular articles such as “a,” “the,” “said,” etc. should be read to recite one or more of the indicated elements unless a claim recites an explicit limitation to the contrary.

What is claimed is:

1. A system comprising a computer including a processor and a memory, the memory including instructions such that the processor is programmed to:
determine an occurrence of intentional drift event; and
in response to determining the occurrence of the intentional drift event, determine a front torque target and a rear torque target.

2. The system of claim 1, wherein the processor is further programmed to adjust a slip target in at least one rear wheel of a vehicle.

3. The system of claim 2, wherein the vehicle comprises an All-Wheel Drive (AWD) vehicle.

4. The system of claim 1, wherein the processor is further programmed to send a command to at least one vehicle actuator to adjust a torque distribution based on the front torque target and the rear torque target.

5. The system of claim 1, wherein the processor is further programmed to determine an occurrence of a drift.

6. The system of claim 5, wherein the processor is further programmed to determine that the occurrence of the drift is the intentional drift event based on an oversteer of a vehicle and no decrease in a throttle of the vehicle.

7. The system of claim 1, wherein the processor is further programmed to send a command to at least one vehicle actuator to modify torque distribution between wheels according to a target side slip angle parameter.

8. A vehicle including a computer, the computer including a processor and a memory, the memory including instructions such that the processor is programmed to:
determine an occurrence of intentional drift event; and
in response to determining the occurrence of the intentional drift event, determine a front torque target and a rear torque target for the vehicle.

9. The vehicle of claim 8, wherein the processor is further programmed to adjust a slip target in at least one rear wheel of the vehicle.

10. The vehicle of claim 8, wherein the vehicle comprises an All-Wheel Drive (AWD) vehicle.

11. The vehicle of claim 8, wherein the processor is further programmed to send a command to at least one vehicle actuator to adjust a torque distribution based on the front torque target and the rear torque target.

12. The vehicle of claim 8, wherein the processor is further programmed to determine an occurrence of a drift.

13. The vehicle of claim 12, wherein the processor is further programmed to determine that the occurrence of the drift is the intentional drift event based on an oversteer of the vehicle and no decrease in a throttle of the vehicle.

14. The vehicle of claim 8, wherein the processor is further programmed to send a command to at least one vehicle actuator to modify torque distribution between wheels according to a target side slip angle parameter.

15. A method comprising:
determining an occurrence of intentional drift event; and
in response to determining the occurrence of the intentional drift event, determining a front torque target and a rear torque target.

16. The method of claim 15, the method further comprising adjusting a slip target in at least one rear wheel of a vehicle.

17. The method of claim 16, wherein the vehicle comprises an All-Wheel Drive (AWD) vehicle.

18. The method of claim 15, the method further comprising sending a command to at least one vehicle actuator to adjust a torque distribution based on the front torque target and the rear torque target.

19. The method of claim 15, the method further comprising determining an occurrence of a drift.

20. The method of claim 19, the method further comprising determining that the occurrence of the drift is the intentional drift event based on an oversteer of a vehicle and no decrease in a throttle of the vehicle.
